(19) United States
(12) Patent Application Publication
(10) Pub. No.: US 2010/0282954 A1
(43) Pub. Date: Nov. 11, 2010

(54) OPTICAL PROBE

(75) Inventors: Bernardus Hendrikus Wilhelmus Hendriks, Eindhoven (NL); Waltherus Cornelis Jozef Bierhoff, Eindhoven (NL); Augustinus Laurentius Braun, Eindhoven (NL); Nenad Mihajlovic, Eindhoven (NL); Gert 'T Hooft, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/810,523

(22) PCT Filed: Dec. 22, 2008
(86) PCT No.: PCT/IB2008/055483

§ 371 Date: Jun. 25, 2010

(30) Foreign Application Priority Data
Jan. 4, 2008 (EP) 08100105.9

(51) Int. Cl. G01J 1/58; G01J 1/00; G02B 26/10

(52) U.S. Cl. 250/227.2; 250/458.1; 359/210.1

(57) ABSTRACT

The present invention relates to an optical probe (1) with an optical guide (2), e.g. an optical fibre, and a lens system (6) rigidly coupled to an end portion (2a) of the optical guide. The probe has a housing (3) with a cavity for the optical guide, the housing having at its distal end a transparent window (4), the window having an insignificant optical power as compared to the optical power of the said lens system (6). Actuation means (8) displaces the 5 lens system so as to enable optical scanning of a region of interest (ROI). The invention is particularly suited for miniature applications e.g. for in-vivo medical application. By attaching the lens system (6) to the optical guide (2) via the mount (7), the field of view (FOV) of the optical probe (1) may be determined directly by the transverse stroke of the optical fibre (2). Hence only a relatively small stroke is required. The field of view is thus 10 effectively no longer limited by the transverse stroke. The optical probe is especially advantageous for non-linear optical imaging where the optical guide may be an optical fibre with a relatively low exit numerical aperture.

### FIELD OF THE INVENTION

The present invention relates to an optical probe suitable for miniature applications, e.g. in-vivo medical inspections and procedures or in industrial inspections, for instance inspection of food or small devices. The invention also relates to a corresponding imaging system and a method for imaging with such an imaging system.

### BACKGROUND OF THE INVENTION

For correct diagnosis of various diseases, e.g. cancer, biopsies are often taken. This can either be via a lumen of an endoscope or via needle biopsies. In order to find the correct position to take the biopsy, various imaging modalities are used such as X-ray, MRI and ultrasound. In case of e.g. prostate cancer in most cases the biopsy is guided by ultrasound. Although helpful, these methods of guidance are far from optimal. The resolution is limited and, furthermore, these imaging modalities can in most cases not discriminate between benign and malignant tissue. As a result we do not know for certain that from the correct part of the tissue a biopsy is taken. We take almost blind biopsies and even if after inspection of the tissue no cancer cells are detected, we do not know for certain that we did not simply miss the right spot to take the biopsy.

In order to improve the biopsy procedure direct inspection of the biopsy position prior of taken the biopsy is required. A way to achieve this is by microscopic inspection at this position. This requires a miniaturised confocal microscope. For even more detailed tissue inspection non-linear optical techniques allow high molecular contrast without the need of staining the tissue (see J. Palero et al. SPIE vol. 6089 (2006) pp. 192-202). These techniques are based on two-photon and second harmonic spectral imaging. In order to make the scanner compatible with these non-linear techniques photonic crystal fibers should be employed with large core diameters in order to reduce non-linear effects in the optical fiber itself. A drawback of these fibers is that they have a low exit beam numerical aperture, typically approximately 0.04. As a consequence when with a fixed objective lens system having a numerical aperture of approximately 0.7, the lateral magnification is 0.057. In order to have a reasonable field of view (ca. 100 micrometer) the transversal stroke of the optical fiber must be as large as 1.75 mm. This is quite large and thus limiting for the downscaling of the microscopic inspection.

US2001/0055462 discloses an integrated endoscopic image acquisition and therapeutic delivery system for use in minimally invasive medical procedures (MIMPs). The system apparently solves the previous trade-off between high quality image and the size of the endoscopes. This system uses directed and scanned optical illumination provided by a scanning optical fibre or light waveguide that is driven by e.g. piezoelectric actuator included at a distal end of an integrated imaging and diagnostic/therapeutic instrument. The directed illumination provides high resolution imaging, at a wide field of view (FOV), and in full colour that matches or excels the images produced by conventional flexible endoscopes. When using scanned optical illumination, the size and number of the photon detectors do not limit the resolution and number of pixels of the resulting image. Additional features include enhancement of topographical features, stereoscopic viewing, and accurate measurement of feature sizes of a region of interest in a patient's body that facilitate providing diagnosis, monitoring, and/or therapy with the instrument. However, this system suffers from the disadvantage that fixed lenses are applied at the end of the endoscope making the field of view more limited. Also the system is not easily for practical application in non-linear optics because the optical system is not directly applicable for single mode fibres, in particularly due to the low numerical aperture of such fibres.

In summary, none of the proposed fiber scanning systems previously disclosed solve the problem related to requiring a larger transverse scanner stroke to have a reasonable field of view (FOV) for the objective lens system.

Hence, an improved optical probe would be advantageous, and in particular a more efficient and/or reliable optical probe would be advantageous.

It is a further object of the present invention to provide an alternative to the prior art.

In particular, it may be seen as an object of the present invention to provide an optical probe that solves the above mentioned problems of the prior art with having a sufficient field of view and a high image resolution.

### SUMMARY OF THE INVENTION

Thus, the above described object and several other objects are intended to be obtained in a first aspect of the invention by providing an optical probe, the probe comprising:

an optical guide,

a lens system rigidly coupled to an end portion of the optical guide,

a housing with a cavity for the optical guide, the housing having at its distal end a transparent window, the window having an insignificant optical power as compared to the optical power of the said lens system, and

actuation means capable of displacing the lens system,

wherein the actuation means is arranged for displacing the lens system so as to enable optical scanning of a region of interest (ROI) outside the said window.

The invention is particularly, but not exclusively, advantageous for obtaining an improved optical probe, particularly suited for miniature applications e.g. for in-vivo medical application. By attaching or mounting the lens system firmly to the optical guide, e.g. the optical fibre, the field of view (FOV) of the optical probe may be determined directly by the transverse stroke of the optical fibre. Hence only a relatively small stroke is required. The field of view is thus effectively no longer limited by the transverse stroke. Because the lens system itself is only used for imaging close to the optical axis (i.e. small field of view), it may allow for simpler (i.e. less complex and thus fewer lens elements) optical designs that eases manufacturing while still having high image resolution.

It should further be mentioned that the optical probe according to the present invention is particularly suited for relative simple and large-scale manufacturing because of the lens system being displaceably mounted on the end portion optical guide. From a practical point of view, this may reduce the needed precision during manufacturing which, in turn, may lower the unit-price per probe. This is especially important because an endoscope, a catheter or needle with the optical probe embedded will normally be disposed after a single use due to sanitary requirements.

In order to have an optical probe that may be applied for non-linear optical processes i.e. where the sample media (in-vivo i.e. body tissue) has a dielectric polarization that responds non-linearly to the applied electric field of the radiation, e.g. the laser light, the present invention also provides significant advantages because of the integrated yet displaceable lens system of the optical probe. Working with non-linear optics may require the use of single-mode optical fibres (SMF) with little or no dispersion (actually distortion) as an optical guide in the probe. However, single-mode optical fibres typically suffer from a relatively low exit numerical aperture limiting the lateral resolution and thus the field of view (FOV). Nevertheless, the optical probe of the present invention provides a simple and robust solution where a high numerical aperture lens system can be incorporated into the probe so as to compensate, at least to some extent, for this property of the single-mode fibre.

Because the optical probe may allow simpler lens designs the amount of lens elements can be reduced. As a result the amount of lens material, which is directly related to the amount of dispersion introduced by it, may be reduced too, leading to reduced pulse broadening in non-linear applications.

In the context of the present invention it is to be understood that the term “optical guide” may include, and is not limited to, optical fibres (multi-mode and single-mode), thin film optical paths, photonic crystal fibres, photonic bandgab fibres (PBG), polarization maintaining fibres, etc. The optical probe may also comprise more than one fibre i.e. a plurality of fibres or a fibre bundle.

In one embodiment, the lens system may be a single lens system because this simplifies manufacturing even more and makes the miniature requirements easier to fulfil.

Possibly, the lens system may comprise an aspherical lens i.e. the lens is not a spherical lens which thereby facilitate a relative high numerical aperture (NA) and accordingly a quite compact lens system is obtained.

In another embodiment, the lens system may comprise a fluid lens with a changeable numerical aperture. For the example, the lens system may comprise a liquid lens with an oil-water two-phase system. Thereby the numerical aperture can be tuned so that focal depth changes are facilitated.

Possibly, the transparent window may comprise a plane section so that the window is non-focussing and thereby do not distort the imaging of the lens system. Specifically, the ratio of the optical power between the transparent window and the lens system is maximum 20%, maximum 10%, or maximum 5%. Other ratios such as maximum 25%, maximum 15%, or maximum 1% are also possible.

Typically, the optical guide may be an optical fibre, and the lens system may be positioned a distance (L) away from the optical exit of the optical fibre, the distance (L) being significantly larger than a core diameter of the optical fibre. The ratio between the distance (L) and the fibre diameter at an exit position may be 5, 10, 20, or 30, and even more. Additionally, or alternatively, the lens system may be rigidly connected to the optical guide with an intermediate mount fixated at the distal end of the optical guide and fixated on the lens system.

Preferably, the lens system at the distal end of the optical guide may be mounted displaceable in a transverse direction of the optical guide in order to enhance the field of view (FOV). It may be elastically mounted.

For some applications, the lens system may have a numerical aperture so as to enable non-linear optical phenomena, e.g. two photons events and frequency mixing as described more detailed below. A numerical aperture of at least 0.4, or at least 0.5, or at least 0.6 makes it easier to perform non-linear optics.

For non-linear applications, the optical guide may be a single-mode optical fibre. Alternatively or additionally, the optical guide may be a photonic crystal fibre, or a polarization maintaining fibre because these kind of optical guide has several advantageous optical properties that are especially beneficial to exploit in the context of the present invention.

For some applications, the optical probe may form part of an endoscope, a catheter, a needle, a biopsy needle, or other similar application as the skilled person will readily realized. It is also contemplated that fields of application of the present invention may include, but is not limited to, fields where small imaging devices are useful, such as in industries using inspection with small-scale devices etc.

In a second aspect, the present invention relates an optical imaging system, the system comprising

an optical probe according to the first aspect,

a radiation source (IS) optically coupled to said optical probe, the probe being arranged for guiding radiation emitted from the radiation source to a region of interest (ROI), and

an imaging detector (ID) optically coupled to said optical probe, the detector being arranged for imaging using reflected radiation from the region of interest (ROI).

In the context of the present invention it is to be understood that the term “radiation source” may comprise any suitable kind of radiation source including, and not limited to, lasers (of any wavelength and any mode of operation i.e. continuous or pulsed of any period incl. femto seconds laser), LEDs, gas-discharge lamps, any kind of luminescence, etc.

Preferably, the radiation source of the optical imaging system may be capable of emitting radiation with an intensity, and/or with a spatial and temporal distribution so at to enable non-linear optical phenomena, e.g. two photon imaging and frequency mixing.

Thus, the system may be a two photon imaging system, or a second harmonic generation (SHG) imaging. Preferably, the radiation source is a laser source with a femto-second (fs) pulsed laser. The imaging system may then comprise appropriate dispersion compensating means. The imaging system may however also perform more linear optical imaging e.g. the imaging system may be a fluorescence imaging system, etc.

In one embodiment, the radiation source may be a pulsed laser with a wavelength, λ, and a pulse length, Δτ, and wherein the focal length, f, of the lens system in the probe satisfy the inequality:

$$f \leq 0.1 \frac{V Δτ}{{NA}_{obj}^{2} λ} ,$$

where V is the Abbe number of the lens system, and NA_{obi} the numerical aperture of the lens system in the optical probe.

In a third aspect, the present invention relates to a method for optical imaging, the method comprising:

providing an optical probe according to the first aspect,

providing a radiation source (IS) which is optically coupled to said optical probe, the probe being arranged for guiding radiation emitted from the radiation source to a region of interest (ROI), and

performing an imaging process with an imaging detector (ID) optically coupled to said optical probe, the detector being arranged for imaging using reflected radiation from the region of interest (ROI).

The individual aspects of the present invention may each be combined with any of the other aspects. These and other aspects of the invention will be apparent from the following description with reference to the described embodiments.

### BRIEF DESCRIPTION OF THE FIGURES

The invention will now be described in more detail with regard to the accompanying figures. The figures show one way of implementing the present invention and is not to be construed as being limiting to other possible embodiments falling within the scope of the attached claim set.

FIG. 1 is a schematic cross-sectional drawing of an optical image probe according to the present invention,

FIG. 2 is a schematic cross-sectional drawing of two possible embodiments of the optical image probe according to the present invention,

FIG. 3 is a schematic drawing of an optical imaging system according to the present invention,

FIG. 4 is a schematic cross-sectional drawing of another embodiment of the optical image probe according to the present invention,

FIG. 5 is a schematic drawing of the optical paths for an optical probe according to the present invention,

FIG. 6 is a schematic drawing of the optical paths for an optical probe having a fluid lens, and

FIG. 7 is a flow chart for a method according to the invention.

### DETAILED DESCRIPTION OF AN EMBODIMENT

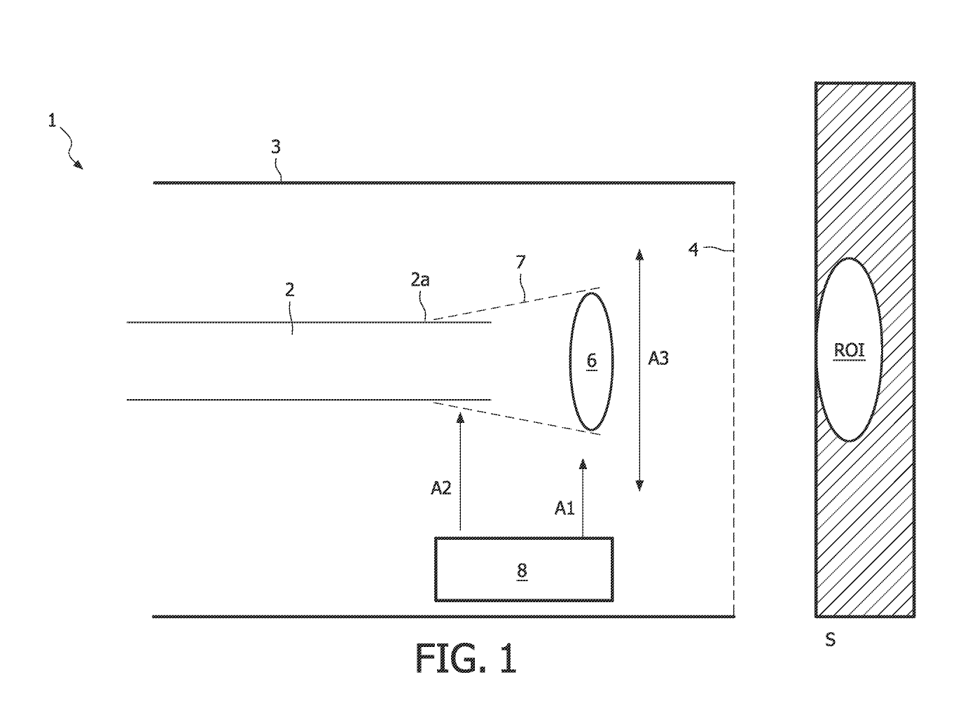

FIG. 1 is a schematic cross-sectional drawing of an optical image probe 1 according to the present invention. The optical probe 1 comprises an optical guide 2, e.g. an optical fibre, and a housing 3 having a cavity wherein the optical guide 1 can be embedded. The housing 3 has at its distal or sampling end a transparent and substantially non-focussing window 4. The window 4 can be a plane section of an optical transport glass or polymer. The window 4 is preferably non-focussing i.e. it has no optical power, but it is contemplated that the window 4 may for some applications have some focussing effect. This is however not usually the case because it may influence the performance of the lens system 6. It is nevertheless contemplated that the exit window 4 in some cases may be a field flattener lens to make the image plain flat and not curved and this requires a small amount of optical power.

A lens system 6 is rigidly coupled to an end portion 2a of the optical guide 2. The lens system 6 is merely for reason of clarity in the Figure shown as a single lens. As will be evident below, the lens system 6 may also have more than one lens and also may contain diffractive elements or mirror elements. The coupling between the lens system 6 and the optical guide 2 is preferably mechanical i.e. there is an intermediate mount 7 keeping the position of the lens system 6 and the optical exit of the optical guide 6 is an fixed position relative to each other.

Actuation means 8 that are capable of displacing the lens system 6 is also provided. The actuation means 8 may be more or less directly actuating on the lens system 6 as indicated by arrow A1. In practical implementation, the actuation means 8 is most likely to be mechanical contact with the mount 7. Alternatively or additionally, the actuation means 8 may be indirectly actuating the lens system 6 via the end portion 2a of the optical guide 2 as indicated by arrow A2. The function of the actuation means 8 is that the actuation means 8 is arranged for displacing the lens system 6 so as to enable optical scanning of a region of interest ROI outside the window 4. Typically, the optical guide 2 is made in a flexible material so as to facilitate inspection on not easy accessible positions, e.g. in-vivo medical inspection and/or sample taking, and in that case the optical guide 2 may be fixated or resting at a point some distance away from the end portion 2a making it possible to elastically displace at least part of the optical guide 2 by the actuation means 8. Various solutions for displacement of an optical guide 2 at an end of a probe are discussed in US2001/0055462, which is hereby incorporated by reference in its entirety.

In order to obtain a compact optical probe 1, lens system 6 preferably comprises an aspherical lens thereby making it possible to have a relative high numerical (NA).

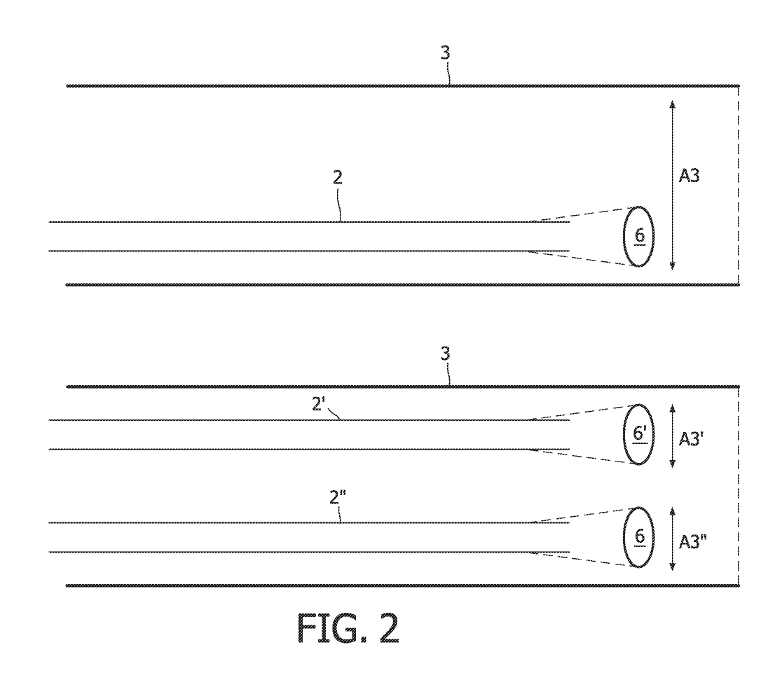

FIG. 2 is a schematic cross-sectional drawing of two possible embodiments of the optical image probe according to the invention. Preferably, the housing 2 is cylindrical symmetrical around a central axis.

In the top view, the optical guide 2 and the lens system 6 is positioned away from a central position in the housing 3. Thus, the lens system 6 may be located close to a side of the housing 3. For some instance of manufacturing this may be a preferred solution. If the optical guide 2 is sufficiently flexible in order to be transversally displaced across a relevant range from an optical imaging point this may posses some advantages. In particular, the actuator 8 can possible be simplified as compared to a central mounting of the optical guide 2 in the optical probe 1. Another reason for doing this is that there will be space for an additional light source or create a working (hollow) channel to administer drugs for instance or instruments for minimal invasive procedures.

It is further contemplated that if the optical guide 2 is sufficiently flexible or elastic the actuation means 8 may also displace the guide 2 along an axial direction of the housing 8. This may be useful for depth scanning along the optical axis of the optical probe 1.

In the bottom view of FIG. 2, there is shown an embodiment where the optical probe 1 comprises two optical guides 2′ and 2″ each guide having a corresponding lens system 6 and 6′, respectively. While this may limit the possible down-scale of the probe 1, it may for some applications be advantageous to two different yet complementary imaging modalities working simultaneously or consecutively during imaging.

A third option would be that the fibre 2 consists of more than one fibre i.e. is a fibre bundle. This is can be used for collecting more light which may be important for non-linear scanning or to be able to scan faster.

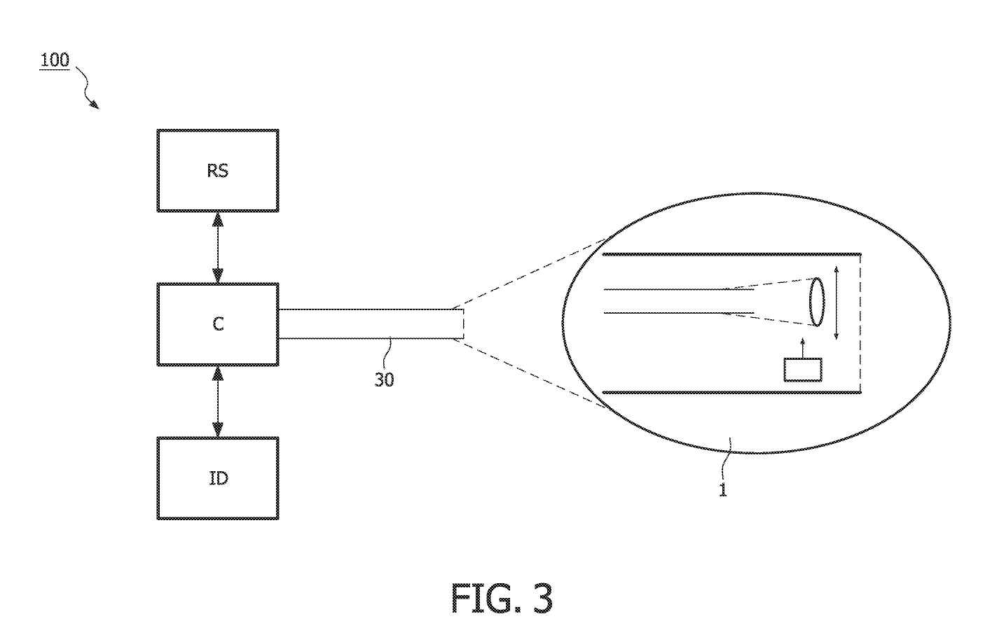

FIG. 3 is a schematic drawing of an optical imaging system 100 according to the present invention. The optical imaging system comprises an optical probe 1 as described above at an end portion of a sample arm 30. The sample arm 30 preferably being highly flexible, and it is possible bendable to some extent. The optical probe 1 is shown the magnified portion and is similarly to FIG. 1.

Additionally, a radiation source RS is optically coupled to the optical probe 1 via a coupler C. The probe 1 is accordingly arranged for guiding radiation, e.g. laser light, emitted from the radiation source RS to a region of interest ROI, and furthermore an imaging detector ID is optically coupled to the optical probe1. The imaging detector is arranged for imaging using reflected radiation from the region of interest ROI in the sample (not shown). The imaging detector ID may also comprise a user interface (UI) so accessing results and/or controlling the imaging process.

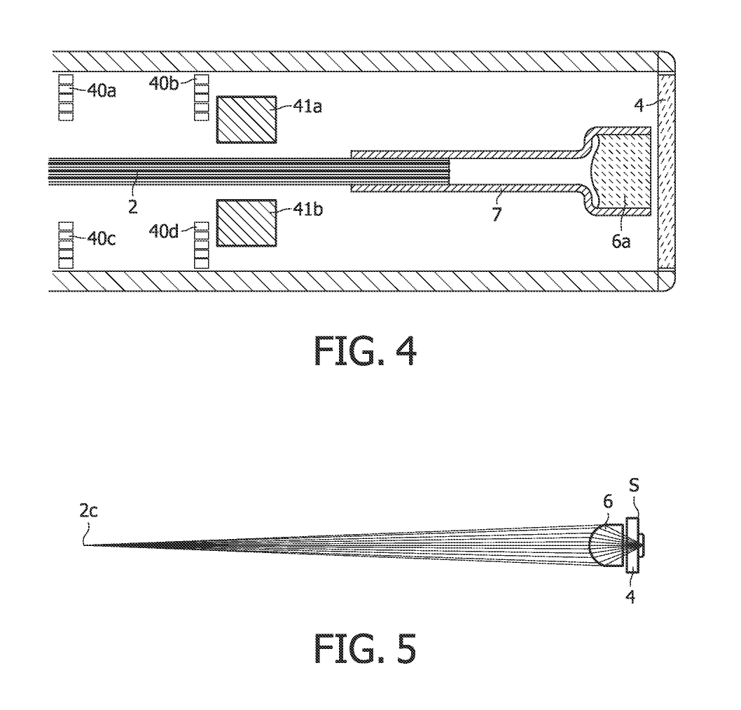

FIG. 4 is a schematic cross-sectional drawing of another embodiment of the optical image probe 1 according to the invention. In order to have a compact lens system an aspherical surface of the lens 6a is applied. By making the lens 6a in an appropriate polymer, a compact lens system 6a can be designed suitable for mass production. Preferably, the polymer should be a low density polymer to provide easy displacement of the lens system 6.

The lens system 6 is positioned a distance L away from the optical exit of the optical fibre 2 as defined by the mount 7. The distance (L) is significantly larger than a core diameter of the optical fibre 2.

The lens system 6 may be part mounted in the housing 3 together with an electromechanical motor system with coils 40a, 40b, 40c, and 40d that are cooperating with magnets 41a and 41b, the magnets being mechanically attached to the optical fibre 2 so as to perform scanning with the optical fibre 2 and the lens 6a by action of the motor system.

In this embodiment, the lens 6a is a singlet plano-aspheric lens 6a in front a thin flat exit window glass plate 4 as evident in FIG. 4. The aspheric lens 6a is made of PMMA and has entrance pupil diameter of 0.82 mm. The numerical aperture (NA) is 0.67 and the focal length (measured in air) is 0.678 mm. The lens system 6a is optimised for wavelength of 780 nm. The exit window 4 is flat and has no optical power.

The free working distance (FWD) of the objective 6 must be larger than the exit window 4 thickness H. The objective lens 6 will be scanned in front of the exit window 4. The exit window 4 must have a certain thickness to be robust. Typically, the thickness is larger than 0.1 mm; H>0.1 mm. This means that the focal length f of the objective 6 must comply with

f>2H (1)

in order to take into account the thickness H and the additional free space needed between objective lens 6 and the exit window 4 in order to allow scanning of the objective in front of the exit window.

The scanning system i.e. the rastering of the lens system 6a employed can be based on resonant scanning based on a piezo motor such as described in Optical Fibers and Sensors for Medical Diagnosis and Treatment Applications, Ed. I Gannot, Proc. SPIE vol. 6083, in the article “A full-color scanning fiber endoscope”, by E. J. Seibel et al. The scanning can alternatively be a resonant scanning of a tuning fork as described in U.S. Pat. No. 6,967,772 and U.S. Pat. No. 7,010,978, or, as another alternative, the scanning system can be an electromagnetic scanner.

FIG. 5 is a schematic drawing of the optical paths for an optical probe 1 as described in connection with FIG. 4. The lens 4 has a relatively high numerical aperture (NA) so the light beam is collected after the exit 2c of optical fibre 2. The light beam is focussed into the tissue S. The tissue in this case is assumed to consist of mainly water.

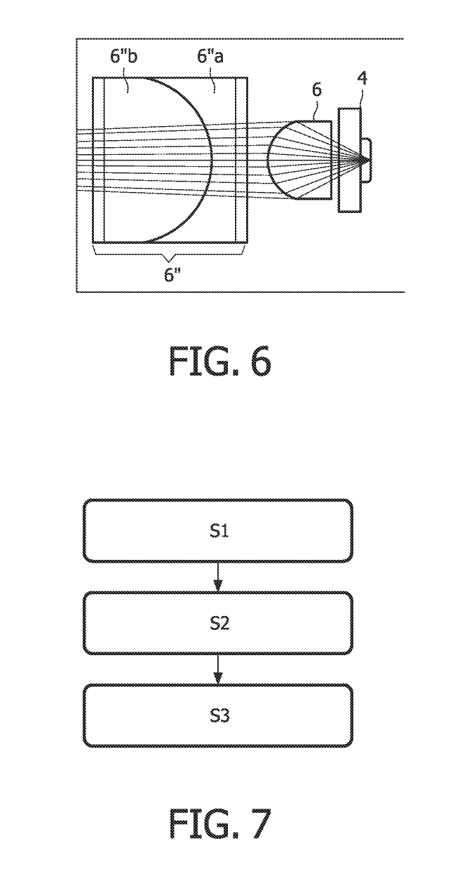

FIG. 6 is a schematic drawing of the optical paths for another optical probe 1 somewhat similar to the probe of FIGS. 4 and 5, but the probe of FIG. 6 has additionally a fluid lens 6″ inserted in between the aspherical lens and the optical fibre (not shown). As for FIG. 5 the sample in front of the probe is tissue. The fluid lens has to immiscible fluids 6″a and 6″b, that can be manipulated so as change the numerical aperture of the lens 6″. Preferably, the phases 6″a and 6″b are an oil and water. Preferably, the fluids are controllable by electrowetting. For further details of an electrowetting lens they may be found in U.S. Pat. No. 7,126,903, which is hereby incorporated by reference in its entirety.

In the following paragraphs some remarks will be given for the case of non-linear optics, where the sample media (in-vivo i.e. body tissue) has a dielectric polarization that responds non-linearly to the applied electric field of the radiation, e.g. the laser light.

Non-linear optics provides a range of various spectroscopy and imaging techniques due to the frequency mixing process. Two examples are two photon imaging system, and a second harmonic generation (SHG) imaging. Thus, radiation source RS, cf. FIG. 3, of the imaging system 100 should be capable of emitting radiation with an intensity, and with a spatial and temporal distribution so at to enable non-linear optical phenomena. The system may also comprise of dispersion compensation means. For further reference on non-linear optics, the skilled reader is referred to “Confocal and Two-Photon Microscopy: Foundations, Applications, and Advances” edited by Alberto Diaspro (Wiley-Liss, Inc., 2002, New York).

In particular, the chromatic dispersion of the lens system 6 must be so small such that the chromatic time shift ΔT between the marginal ray and the principle ray of the objective lens 6 must be smaller the pulse length in time Δτ of the pulsed radiation source RS i.e. a laser. This sets the following requirement on the lens 6:

From Z. Bor in J. Mod. Opt. 35, (1988), 1907, it follows that one can write

$$\vert Δ T \vert = \frac{{NA}_{obj}^{2} λ f}{2 c ( n - 1 )} \frac{d n}{d λ} \qquad ( 2 )$$

where λ is the wavelength, NA_{obj} numerical aperture of the lens objective, f the focal length of the lens objective, c speed of light, n refractive index lens and dn/dλ, is the change in refractive index with wavelength. Using the expressing for the Abbe number V for dispersion of the lens material one finds:

$$\vert Δ T \vert = \frac{{NA}_{obj}^{2} f λ}{2 c ( {λ}_{F} - {λ}_{C} ) V} . \qquad ( 3 )$$

Using λ_{F}=486.13 nm and λ_{C}=656.27 nm, this finally gives

$$f \leq 0.1 \frac{V Δτ}{{NA}_{obj}^{2} λ} \qquad ( 4 )$$

where λ is the wavelength in [nm], V Abbe number, NA_{obj} numerical aperture objective, Δτ pulse length of the laser [fs], f focal length objective in [mm].

For objectives consisting out of more than one lens material, in equation (4) the lowest Abbe number of the materials should be selected.

The numerical aperture of the large core photonic crystal fibre is normally quite small, typically NA_{f}˜0.04. In the following, the numerical aperture of the objective is given by NA_{obj}. The distance L between exit of the fibre 2 and objective lens 6, must be limited in order to make the additional weight attached to the fibre 2 limited. Typically, if D_{f} is the diameter of the optical fibre 2 then one must have that the distance L is substantially larger than the diameter D_{f} of the fibre, but limited to typically L<25D_{f}.

This condition may be reformulated into the following constraint. Using D=2NA_{obj}f and D˜2NA_{f}L, the inequality above may also be given by

$$f < 25 \frac{{NA}_{f}}{{NA}_{obj}} {D}_{f} \qquad ( 5 )$$

Another constraint is that the numerical aperture (NA) of the objective lens 6; NA_{obj}; should preferably fulfil the requirement that NA_{obj}>0.5 in order to be able to produce a two-photon interaction at moderate laser power. Thus;

NA_{obj}>0.5 (6)

Possible, NA_{obj} could also be at least 0.3, at least 0.4, at least 0.6, or at least 0.7.

The objective lens 6 should also be as easy as possible to manufacture, hence the pupil diameter D of the objective is preferably larger than about 0.2 mm. This translates into the constraint that

$$f > \frac{1}{10 {NA}_{obj}} \qquad ( 7 )$$

with f in [mm].

The objective 6 is at a distance of 10.0 mm of the exit of the fibre and is made of PMMA have refractive index 1.4862 at 780 nm wavelength and Abbe number V=57.4. The pupil diameter of the lens is D=0.82 mm and the thickness on axis is 0.647 mm. The numerical aperture of the objective is NA_{obj}=0.67. The formula describing the “sag” or z-coordinate of a surface is given by

$$z ( r ) = \frac{{r}^{2}}{R ( 1 + \sqrt{\frac{1 - ( 1 + k ) {r}^{2}}{{R}^{2}}} )} + \begin{matrix}{A}_{2} {r}^{2} + {A}_{4} {r}^{4} + {A}_{6} {r}^{6} + \\ {A}_{8} {r}^{8} + {A}_{10} {r}^{10} + {A}_{12} {r}^{12} + \\ {A}_{14} {r}^{14} + {A}_{16} {r}^{16}\end{matrix} \qquad ( 8 )$$

where R denotes the lens radius of each surface, r denotes the distance from the optical axis and z the position of the sag of the surface in the z-direction along the optical axis. The coefficients A2 to A16 are the aspherical coefficients of the surface. They are given by:

### R=0.2743594 mm

k=−6.54
A2=−0.30479289 mm⁻¹
A4=28.308315 mm⁻³
A6=−527.54424 mm⁻⁵
A8=7899.4624 mm⁻⁷
A10=−77012.804 mm⁻⁹
A12=459584.12 mm⁻¹¹
A14=−1510148.3 mm⁻¹³
A16=2090233.2 mm⁻¹⁵

The distance between the objective 6 and the glass plate exit window 4 is 0.1 mm. The exit window 4 is 0.2 mm thick and made of BK7 Schott glass have refractive index 1.5111 at 780 nm wavelength and Abbe number, V, of 64.2. The beam is focused into a water-like tissue have refractive index 1.330 at 780 nm and Abbe number 33.1.

FIG. 7 is a flow chart for a method according to the invention. The method comprises:

S1 providing an optical probe 1 according to claim the first aspect,

S2 providing a radiation source (RS) which is optically coupled through C to said optical probe 1, the probe being arranged for guiding radiation emitted from the radiation source to a region of interest (ROI), and

S3 performing an imaging process with an imaging detector (ID) optically coupled to said optical probe 1, the detector being arranged for imaging using reflected radiation from the region of interest (ROI).

The invention can be implemented by means of hardware, software, firmware or any combination of these. The invention or some of the features thereof can also be implemented as software running on one or more data processors and/or digital signal processors.

The individual elements of an embodiment of the invention may be physically, functionally and logically implemented in any suitable way such as in a single unit, in a plurality of units or as part of separate functional units. The invention may be implemented in a single unit, or be both physically and functionally distributed between different units and processors.

Although the present invention has been described in connection with the specified embodiments, it should not be construed as being in any way limited to the presented examples. The scope of the present invention is to be interpreted in the light of the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1. An optical probe (1), the probe comprising:
an optical guide (2),
a lens system (6) rigidly coupled to an end portion (2a) of the optical guide,
a housing (3) with a cavity for the optical guide, the housing having at its distal end a transparent window (4), the window having an insignificant optical power as compared to the optical power of the said lens system (6), and
actuation means (8) capable of displacing the lens system,
wherein the actuation means (8) is arranged for displacing the lens system (6) so as to enable optical scanning of a region of interest (ROI) outside the said window.

2. The probe according to claim 1, wherein the lens system (6) is a single lens system.

3. The probe according to claim 1, wherein the lens system (6) comprises an aspherical lens.

4. The probe according to claim 1, wherein the lens system (6) comprises a fluid lens (6″) with a changeable numerical aperture.

5. The probe according to claim 1, wherein the transparent window (4) comprises a plane section.

6. The probe according to claim 1, wherein the ratio of the optical power between the transparent window (4) and the lens system (6) is maximum 20%, maximum 10%, or maximum 5%.

7. The probe according to claim 1, wherein the optical guide (2) is an optical fibre, the lens system (6) being positioned a distance (L) away from the optical exit of the optical fibre (2), the distance (L) being significantly larger than a core diameter (D_{f}) of the optical fibre.

8. The probe according to claim 1, wherein the lens system (6) is rigidly connected to the optical guide (2) with an intermediate mount (7) fixated at the distal end (2a) of the optical guide and fixated on the lens system.

9. The probe according to claim 1, wherein the lens system (6) at the distal end (2a) of the optical guide is mounted displaceable in a transverse direction of the optical guide (2).

10. The probe according to claim 1, wherein the lens system (6) has a numerical aperture so as to enable non-linear optical phenomena.

11. The probe according to claim 1, wherein the optical guide is a single-mode optical fibre.

12. The probe according to claim 1, wherein the optical guide is a photonic crystal fibre, or a polarization maintaining fibre.

13. The probe according to claim 1, wherein the probe forms part of an endoscope, a catheter, a needle, or a biopsy needle.

14. An optical imaging system (100), the system comprising
an optical probe (1) according to claim 1,
a radiation source (RS) optically coupled to said optical probe (1), the probe being arranged for guiding radiation emitted from the radiation source to a region of interest (ROI), and
an imaging detector (ID) optically coupled to said optical probe (1), the detector being arranged for imaging using reflected radiation from the region of interest (ROI).

15. The optical imaging system according to claim 14, wherein the radiation source (RS) of the optical imaging system is capable of emitting radiation with an intensity, and/or with a spatial and temporal distribution so at to enable non-linear optical phenomena.

16. The optical imaging system according to claim 14, the system being a two photon imaging system, a second harmonic generation (SHG) imaging, or a fluorescence imaging system.

17. The optical imaging system according to claim 16, wherein the radiation source is a pulsed laser with a wavelength, λ, and a pulse length, λτ, and
wherein the focal length, f, of the lens system in the probe satisfy:
$$f \leq 0.1 \frac{V Δτ}{{NA}_{obj}^{2} λ} ,$$
where V is the Abbe number of the lens system, and NA_{obj} the numerical aperture of the lens system.

18. A method for optical imaging, the method comprising:
providing an optical probe (1) according to claim 1,
providing a radiation source (RS) which is optically coupled to said optical probe, the probe being arranged for guiding radiation emitted from the radiation source to a region of interest (ROI), and
performing an imaging process with an imaging detector (ID) optically coupled to said optical probe, the detector being arranged for imaging using reflected radiation from the region of interest (ROI).
